(19) United States
(12) Patent Application Publication
(10) Pub. No.: US 2024/0368342 A1
(43) Pub. Date: Nov. 7, 2024

(54) Methods for Preparing Polyhydroxyalkanoate Polymer Compositions

(71) Applicant: ExxonMobil Chemical Patents Inc., Baytown, TX (US)

(72) Inventors: Gursu Culcu, Humble, TX (US); Carlos R. Lopez-Barron, Houston, TX (US); Charles J. Harlan, Houston, TX (US); John R. Hagadorn, Houston, TX (US); Glen E. Alliger, Houston, TX (US)

(21) Appl. No.: 18/681,935

(22) PCT Filed: Jul. 18, 2022
(86) PCT No.: PCT/US2022/037455

§ 371 Date: Feb. 7, 2024

Related U.S. Application Data
(60) Provisional application No. 63/231,821, filed on Aug. 11, 2021.

(51) Int. Cl. C08G 63/82; C08G 63/08; C08G 63/81; C08G 63/84

(52) U.S. Cl. CPC C08G 63/823; C08G 63/08; C08G 63/81; C08G 63/84

(57) ABSTRACT

A method for preparing a polyhydroxyalkanoate (PHA) polymer by ring-opening polymerization, comprising: polymerizing a lactone in a presence of a solvent and a catalyst with a yttrium metal center under reaction conditions; controlling the polymerization to derive a polymer from the lactone with the polymer having predetermined tensile properties, wherein a Tm of the polymer ranges from 90 to 170° C. and the tensile properties are determined by a ligand of the catalyst, the solvent, and a temperature of the reaction conditions; and recovering the polymer.

### CROSS REFERENCE TO RELATED APPLICATIONS

This application claims the benefit of and priority to U.S. Provisional Application No. 63/231,821 filed Aug. 11, 2021, the disclosure of which is incorporated herein by reference.

### TECHNOLOGICAL FIELD

Exemplary embodiments described herein relate to a method for preparing polyhydroxyalkanoates (PHAs) and polymers made from such method.

### BACKGROUND

PHA polymers have been particularly interesting for researchers since PHA is believed to have very similar mechanical properties compared to LDPE or iPP. The most common PHA is poly(3-hydroxybutyrate) (PHB) which is an aliphatic polyester produced by bacteria and other living organisms. PHA can be produced by bacteria such as Bacilus megaterium, cupriavidus necator, or ralstonia eutroph. However, bacteria produces only isotactic PHA resulting in a very high crystalline polymer with a Tm up to 180° C. which is very close to the decomposition temperature. Therefore it is very challenging to process these polymers and have little commercial value. These polymers also degrade very fast by microbial organisms.

In order to lower Tm and improve their properties, syndiorich PHA polymers have been proposed. However, these reactions are often too slow (days to weeks) making them industrially irrelevant. Contrary to enzymes, synthetic methods such as transition metal or main group based catalysts can be used to synthesize syndiorich or atactic PHA polymers. For example, tin-based catalysts have been reported to produce atactic and syndiorich PHA polymers. (See, for example, Hori, Y. et al. (1999) “Ring-Opening Copolymerization of (R)-β-Butyrolactone with Macrolide: A New Series of Poly(Hydroxyalkanoate)s,” Macromolecules, v.32(10), pp. 3537-3539; Hori, Y. et al. (1993), “Ring-Opening Polymerization of Optically Active.Beta.-Butyrolactone using Distannoxane Catalysts: Synthesis of High-Molecular-Weight poly(3-hydroxybutyrate),” Macromolecules, v.26 (20), pp. 5533-5534; Kricheldorf, H. R. et al. (1997) “Polylactones. 41. Polymerizations of β-D,L-Butyrolactone with Dialkyltinoxides as Initiators,” Macromolecules, v.30 (19), pp. 5693-5697; and Moller, M. et al. (2000) “Sn(OTf)₂ and SC(OTf)₃: Efficient and Versatile Catalysts for the Controlled Polymerization of Lactones,” Jrnl. of Poly. Sci.: Part A: Polymer Chem., v. 38(11), pp. 2067-2074, each of which is incorporated by reference herein in its entirety.) However, these reactions are often too slow (days to weeks) making them industrially irrelevant. Although isotactic PHA polymers can be synthesized by bacteria, they have also been reported by chromium based catalysts. (see, for example, Zintl, M. et al. (2008) “Variably Isotactic Poly (hydroxybutyrate) from Racemic β-Butyrolactone: Microstructure Control by Achiral Chromium(III) Salophen Complexes,” Angew. Chem. Int. Ed., v. 47(18), pp. 3458-3460, the entirety of which is hereby incorporated by reference.) More recently, aluminum, zinc, indium, Group 3 and lanthanide based catalysts have been developed to produce atactic and syndiotactic PHA polymers. (see, for example, Rieth, L. et al. (2002) “Single-Site Beta-Diiminate Zinc Catalysts for the Ring-Opening Polymerization of Beta-Butyrolactone and Beta-Valerolactone to Poly(3-Hydroxyalkanoates,” J. Am. Chem. Soc., v. 124(51), pp. 15239-15248; Ebrahimi, T. et al. (2016) “Highly Active Chiral Zinc Catalysts for Immortal Polymerization of β-Butyrolactone Form Melt Processable Syndio-Rich Poly(hydroxybutyrate),” Macromolecules, v. 49(23), pp. 8812-8824; Lyubov, D. et al. (2019) “Rare-Earth Metal Complexes as Catalysts for Ring-Opening Polymerization of Cyclic Esters,” Coordination Chemistry Reviews, v. 392, pp. 83-145; Shaik, M. et al. (2019) “Cyclic and Linear Polyhydroxylbutyrates from Ring-Opening Polymerization of β-Butyrolactone with Amido-Oxazolinate Zinc Catalysts,” Macromolecules, v. 52(1), pp. 157-166; Sinenkov, M. et al. (2011) “Neodymium Borohydride Complexes Supported by Diamino-bis(phenoxide) Ligands: Diversity of Synthetic and Structural Chemistry, and Catalytic Activity in Ring-Opening Polymerization of Cyclic Esters,” New J. Chem., v. 35, pp. 204-212; Mori, T. et al. (2013) “Superhelix Structure in Helical Conjugated Polymers Synthesized in an Asymmetric Reaction Field,” Macromolecules, v. 46(17), pp. 6765-6776; Ajellal, N. et al. (2009) “Syndiotactic-Enriched Poly(3-hydroxybutyrate)s via Stereoselective Ring-Opening Polymerization of Racemic β-Butyrolactone with Discrete Yttrium Catalysts,” Macromolecules, v. 42(4), pp. 987-993; Altenbuchner, P. et al. (2015) “Mechanistic Investigations of the Stereoselective Rare Earth Metal-Mediated Ring-Opening Polymerization of β-Butyrolactone,” Chem. Eur. J., 2015, v. 21(39), pp. 13609-13617; Organometallics 2018, 37, 837-840, and Ebrahimi, T. et al. (2015) “Synthesis and Rheological Characterization of Star-Shaped and Linear Poly(hydroxybutyrate),” Macromolecules, v. 48(18), pp. 6672-6681, each of which is incorporated herein by reference in its entirety.)

Conventional results indicate that ligands of the type ONO, ONNO or ONYO (Y=amine, ether, thioether, heteroatom containing cyclic functional group etc.) may be suitable for ROP of lactones including BBL. However, the examples reported in literature are limited to only a few R groups such as halogen atoms, —CPh₃, —CMePh₂, —CMe₂tBu and CMe₂CF₃Ph. For the ONO type ligands the selection of R is even more limited, essentially limited to silyl groups such as SiPh₃ and SiMe₂tBu (see, for example, Grunova, E. et al. (2010) “Group 3 Metal Complexes Supported by Tridentate Pyridine- and Thiophene-Linked Bis(Naphtholate) Ligands: Synthesis, Structure, and use in Stereoselective Ring-Opening Polymerization of Racemic Lactide and B-Butyrolactone,” Dalton Trans., 2010, v. 39(29), pp. 6739-6752, the entirety of which is hereby incorporated by reference in its entirety.)

### SUMMARY

A method for preparing a polyhydroxyalkanoate (PHA) polymer by ring-opening polymerization, comprising: polymerizing a lactone in a presence of a solvent and a catalyst with a yttrium metal center under reaction conditions; controlling the polymerization to derive a polymer from the lactone with the polymer having predetermined tensile properties, wherein a Tm of the polymer ranges from 90 to 170° C., and the tensile properties are determined by a ligand of the catalyst, the solvent, and a temperature of the reaction conditions; and recovering the polymer.

A method for preparing a polyhydroxyalkanoate (PHA) polymer by ring-opening polymerization, comprising: polymerizing a lactone in a presence of a solvent and a catalyst with a yttrium metal center under reaction conditions, wherein the catalyst was formed in situ from a metal ligand combination selected from the group consisting of

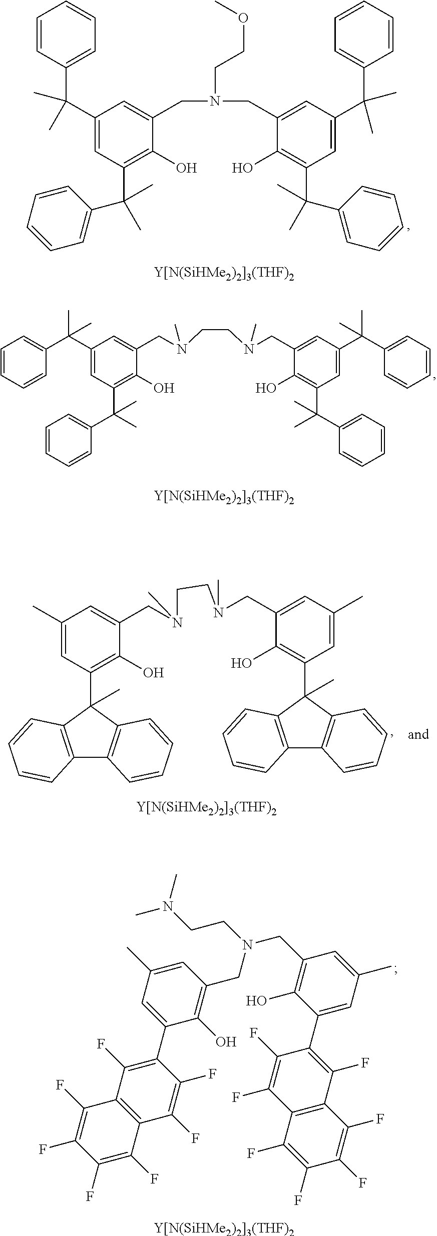

and recovering the polymer.

### BRIEF DESCRIPTION OF THE FIGURES

FIG. 1 is a graph illustrating a linear relationship between Tm and Pr.

FIG. 2 is a graph illustrating strain-stress curves of selected PBBL homopolymers with different tacticity, embodying the present technological advancement.

### DETAILED DESCRIPTION

For the purposes of this invention and the claims thereto, the new numbering scheme for the Periodic Table Groups is used as described in Chemical and Engineering News, v. 63(5), pg. 27 (1985). Therefore, a “group 4 metal” is an element from group 4 of the Periodic Table, e.g. Hf, Ti, or Zr, and a “group 3 metal” is an element from group 3 of the Periodic Table, e.g., scandium or yttrium.

RT is room temperature and is 23° C. unless otherwise indicated.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are reported in units of g/mol (g mol⁻¹).

The present technological advancement describes new ligand/metal combinations that have been used to produce new PHA polymers. In summary, a series of ligands were screened in combination with Y[N(SiHMe₂)₂]₃(THF)₂) to generate the catalyst in situ, a linear relationship was determined between Tm and Pr, solvent and temperature effect on the resulting polymer properties was discovered, and methods to lower Tm to make the polymers more processable and commercially relevant were discovered by taking advantage of the alpha isomer produced during the epoxide carbonylation.

Exemplary implications of the present technological advancement is that a co-monomer may not be necessary to access these type of PHA polymers as opposed to the ones reported in literature where longer chain alkyls were used to copolymerize with BBL.

Moreover, the present technological advancement shows how to control the tensile properties of the polymers using the methods listed above allowing for the design of polymers with desired properties towards commercial applications.

In order to fully understand the effect of substitution pattern and the choice of solvent or temperature on the polymer properties, a ligand screening was conducted using a Group 3 metal precursor (Y[N(SiHMe₂)₂]₃(THF)₂) to be consistent with literature as it is one of the most common metal precursors for this type of chemistry. THF refers to tetrahydrofuran. Since both the ligands and the metal precursor were found to be soluble in the solvents of interest, it was decided to generate the catalyst in situ and combine with the lactone for polymerization.

While many exemplary embodiments described herein use (Y[N(SiHMe₂)₂]₃(THF)₂), it is not the only metal precursor useable with the present technological advancement. More generally, the metal precursor can by YQ₃Sₙ, where Q is NR′₂, R″₃, or X₃, S is a Lewis base including solvent molecules such as nitrogen donors (amines, pyridine, nitrile groups etc.), oxygen donors (ethers such as diethyl ether, Methyl tert-butyl ether, tetrahydrofuran, trialkylphosphine oxides etc.), phosphine donors (trialkyl phosphine such as tributylphosphine, triphenylphosphine etc.), sulfur donors such as thiophene, dimethyl sulfide etc., R′is a hydrocarbyl group including Si groups, R″ is a hydrocarbyl group (including oxygen containing fragments) such as CH₂CMe₃, CH₂SiMe₃, CH₂C(CH₃)₂(C₆H₅), —CH₂Si(OCH₃)₃, n is 0 to 3, and X is F, Cl, Br, or I.

In some exemplary embodiments, THF can be replaced by benzonitrile (see, for example, Westerhausen, et al., (1995) “Bis(trimethylsilyl)amide und-methanide des Yttriums—Molekülstrukturen von Tris(diethylether-O)lithium-(u-chloro)-tris[bis(trimethylsilyl) methyl]yttriat, solvensfreiem Yttrium-tris[bis(trimethylsilyl)amid] sowie dem Bis(benzonitril)-Komplex,” Jrnl. Inorg. Chem., v. 621(5), pp. 837-850, the entire contents of which is hereby incorporated by reference). In some exemplary embodiments, THF can be replaced by diethyl ether (see, for example, Eedugurala, N. et al. (2017) β-SiH-Containing Tris(silazido) Rare-Earth Complexes as Homogeneous and Grafted Single-Site Catalyst Precursors for Hydroamination,” Organometalics, v. 36(6), pp. 1142-1153, the entire contents of which is hereby incorporated by reference).

In some embodiments of the present technological advancement, Y(CH₂SiCH₃)₃(THF)₂ can be used as the metal precursor (see, for example, Long et al. (2015) “Rare-earth metal alkyl complexes bearing an alkoxy N-heterocyclic carbene ligand: synthesis, characterization, catalysis for isoprene polymerization,” New Journal of Chemistry, Issue 10, pp. 7682-7687, the entire contents of which is hereby incorporated by reference).

In a typical polymerization reaction, the metal precursor dissolved in a suitable solvent was added to a solution of ligand at room temperature. The solution was then stirred for three to five minutes to allow the active species to form. The catalyst solution then was injected into a solution of the lactone and stirred. The polymers were isolated by precipitating into methanol, washing with methanol and a hydrocarbon solvent, and drying under vacuum. The tacticity (or lack of) was determined by ¹³C NMR spectroscopy as described in literature (see, Ebrahimi, Tannaz, (2017) “Synthesis and rheological characterization of polyhydroxybutyrate with different topologies and microstructures,” University of British Columbia, 247 pages, the entirety contents of which are hereby incorporated by reference) and Tm values were measured by DSC.

Lactones usable with the present technological advancement include the following.

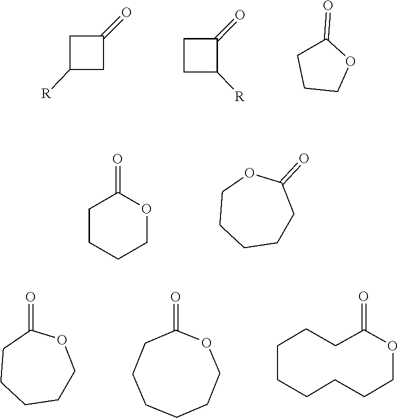

Table 1 describes data obtained from the experiments described below.

TABLE 1

| Entry | Mw (MALLS) | Mn (DRI) | Tm | Pr |
|---|---|---|---|---|
| 1 | 16,155 | 9,267 | 152.6 | 0.85 |
| 2 | 39,815 | 28,291 | 162 | 0.88 |
| 3 | 31,730 | 27,014 | 167.28 | 0.89 |
| 4 | 49,332 | 36,824 | 103.1 | 0.72 |
| 5 | 24,229 | 17,586 | 154.25 | 0.85 |
| 6 | 48,115 | 33,892 | 95.11 | 0.69 |
| 7 | 9,190 | 9,821 | 123.5 | 0.76 |
| 8 | 11,511 | 5,547 | 147.2 | 0.83 |
| 9 | NR | NR | NR | NR |
| 10 | NR | NR | NR | NR |
| 11 | NR | NR | NR | NR |
| 12 | ND | ND | 0.83 | 142 |
| 13 | ND | ND | NA | NA |
| 14 | ND | ND | ND | ND |
| 15 | 29,940 | 23,314 | NA | 0.53 |
| 16 | 23,158 | 15,015 | 151.6 | 0.79 |
| 17 | 38,810 | 22,552 | 148.9 | 0.72 |
| 18 | ND | ND | 108.8 | 0.75 |
| 19 | ND | ND | 69 | 0.89 |
| 20 | ND | ND | ND | ND |
| 21 | ND | ND | ND | ND |
| 22 | ND | ND | 130.8 | 0.78 |
| 23 | ND | ND | 96.7 | 0.71 |
| 24 | ND | ND | 115 | 0.76 |
| 25 | ND | ND | 113 | 0.78 |
| 26 | ND | ND | 132 | 0.79 |
| 27 | ND | ND | 97.5 | 0.70 |
| 28 | ND | ND | ND | 0.78 |

(ND = not determined, NR = no visible reaction occurred)

Any two data points in Table 1 define a range for the measured characteristic or property.

Table 2 describes data obtained from the experiments for a specific ligand family described below.

TABLE 2

| | | | | | Mw | Mn | | | |
|---|---|---|---|---|---|---|---|---|---|
| Entry | Ligand | Lactone | T | T | (MALLS) | (DRI) | PDI | Pr | Tm |
| 1 | 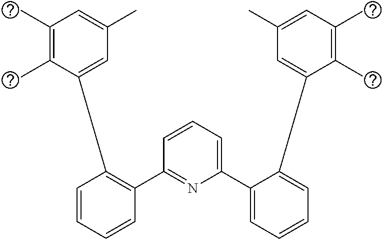 [symbol] | 600 equiv. | rt | over- night | 29,940 | 23,314 | 1.28 | 0.53 | NA |
| 2 | 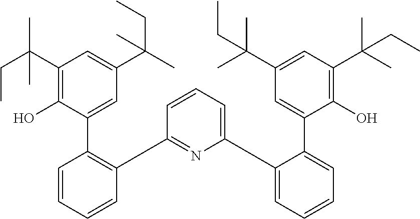 [SMILES: CCC(C)(C)c1cc(-c2ccccc2-c2cccc(-c3ccccc3-c3cc(C(C)(C)CC)cc(C(C)(C)CC)c3O)n2)c(O)c(C(C)(C)CC)c1] | 600 equiv. | rt | over- night | 23,158 | 15,015 | 1.54 | 0.79 | 151.6 |
| 3 | 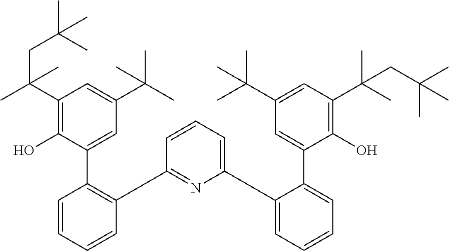 [SMILES: CC(C)(C)CC(C)(C)c1cc(C(C)(C)C)cc(-c2ccccc2-c2cccc(-c3ccccc3-c3cc(C(C)(C)C)cc(C(C)(C)CC(C)(C)C)c3O)n2)c1O] | 600 equiv. | rt | over- night | 38,810 | 22,552 | 1.72 | 0.72 | 148.9 |
| 4 | 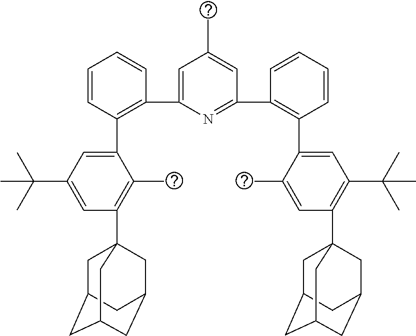 [SMILES: Cc1cc(-c2ccccc2-c2cc(C(C)(C)C)c(C34CC5CC(CC(C5)C3)C4)cc2C)nc(-c2ccccc2-c2cc(C(C)(C)C)cc(C34CC5CC(CC(C5)C3)C4)c2C)c1] | 1,000 equiv. | rt | 2 days | 70,555 | 58,310 | 1.21 | 0.47 | ND |
| 5 | 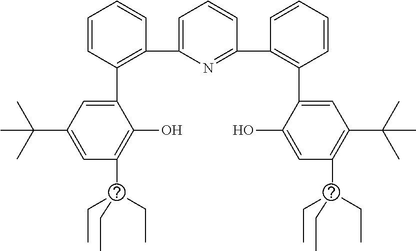 [SMILES: CCC(CC)(CC)c1cc(O)c(-c2ccccc2-c2cccc(-c3ccccc3-c3cc(C(C)(C)C)cc(C(CC)(CC)CC)c3O)n2)cc1C(C)(C)C] | 1,000 equiv. | rt | 2 days | 90,871 | 57,880 | 1.57 | 0.78 | 144.75 |
| 6 | 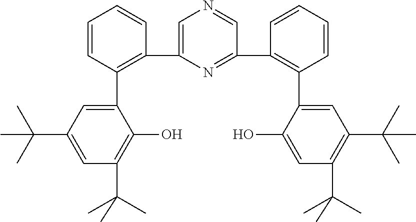 [SMILES: CC(C)(C)c1cc(-c2ccccc2-c2cncc(-c3ccccc3-c3cc(C(C)(C)C)c(C(C)(C)C)cc3O)n2)c(O)c(C(C)(C)C)c1] | 1,000 equiv. | rt | 2 days | 33,423 | 23,538 | 1.42 | 0.62 | None |
| 7 | 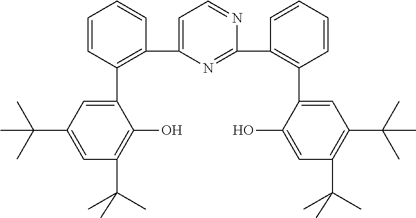 [SMILES: CC(C)(C)c1cc(-c2ccccc2-c2ccnc(-c3ccccc3-c3cc(C(C)(C)C)c(C(C)(C)C)cc3O)n2)c(O)c(C(C)(C)C)c1] | 1,000 equiv. | rt | 2 days | 17,953 | 14,137 | 1.27 | 0.53 | ND |
| 8 | 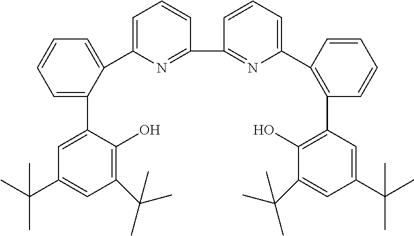 [SMILES: CC(C)(C)c1cc(-c2ccccc2-c2cccc(-c3cccc(-c4ccccc4-c4cc(C(C)(C)C)cc(C(C)(C)C)c4O)n3)n2)c(O)c(C(C)(C)C)c1] | 1,000 equiv. | rt | 2 days | 12,990 | 11,496 | 1.13 | 0.57 | ND |
| 9 | 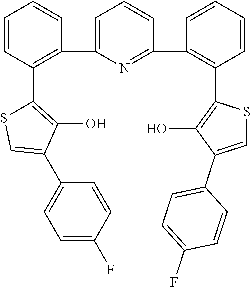 [SMILES: Oc1c(-c2ccc(F)cc2)csc1-c1ccccc1-c1cccc(-c2ccccc2-c2scc(-c3ccc(F)cc3)c2O)n1] | 1,000 equiv. | rt | 2 days | 4,564 | 3,804 | 1.20 | 0.58 | ND |
| 10 | 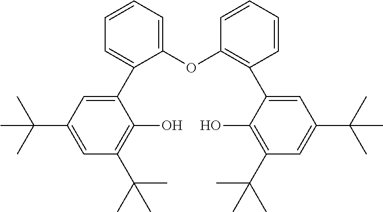 [SMILES: CC(C)(C)c1cc(-c2ccccc2Oc2ccccc2-c2cc(C(C)(C)C)cc(C(C)(C)C)c2O)c(O)c(C(C)(C)C)c1] | 1,000 equiv. | rt | 2 days | 9,597 | 7,617 | 1.26 | 0.54 | ND |

[symbol]

indicates data missing or illegible when filed

Any two data points in Table 2 define a range for the measured characteristic or property.

MALLS refers to multi angle laser light scattering, and is sometimes also referred to as MALS (multi angle light scattering). DRI refers to differential diffraction index.

The ligands used in Table 1 are as shown below and their ordering corresponds to the entries 1-28 in Table 1. Further information on the synthesis of these ligands, and other ligands useable with the present technological advancement, can be found in U.S. Pat. Nos. 10,611,857, 10,927,134, and 10,138,257, and U.S. Patent Publications 2020/0101450, 2020/0255555, 2020/0254431, 2020/0255556, and 2020/0255553, each of which is hereby incorporated by reference in its entirety.

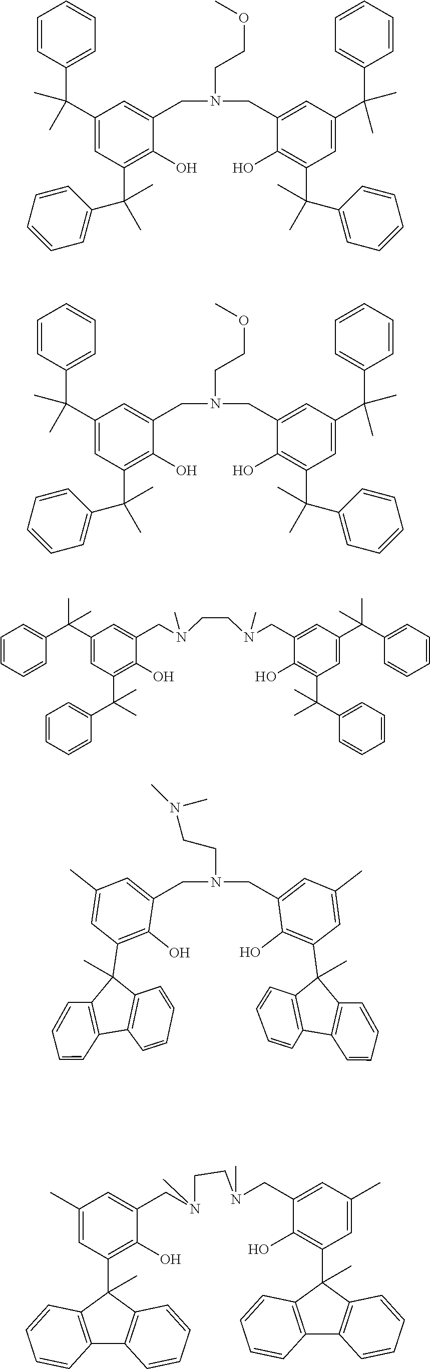 [SMILES: COCCN(Cc1cc(C(C)(C)c2ccccc2)cc(C(C)(C)c2ccccc2)c1O)Cc1cc(C(C)(C)c2ccccc2)cc(C(C)(C)c2ccccc2)c1O ; COCCN(Cc1cc(C(C)(C)c2ccccc2)cc(C(C)(C)c2ccccc2)c1O)Cc1cc(C(C)(C)c2ccccc2)cc(C(C)(C)c2ccccc2)c1O ; CN(CCN(C)Cc1cc(C(C)(C)c2ccccc2)cc(C(C)(C)c2ccccc2)c1O)Cc1cc(C(C)(C)c2ccccc2)cc(C(C)(C)c2ccccc2)c1O ; Cc1cc(CN(CCN(C)C)Cc2cc(C)cc(C3(C)c4ccccc4-c4ccccc43)c2O)c(O)c(C2(C)c3ccccc3-c3ccccc32)c1 ; Cc1cc(CN(C)CCN(C)Cc2cc(C)cc(C3(C)c4ccccc4-c4ccccc43)c2O)c(O)c(C2(C)c3ccccc3-c3ccccc32)c1]

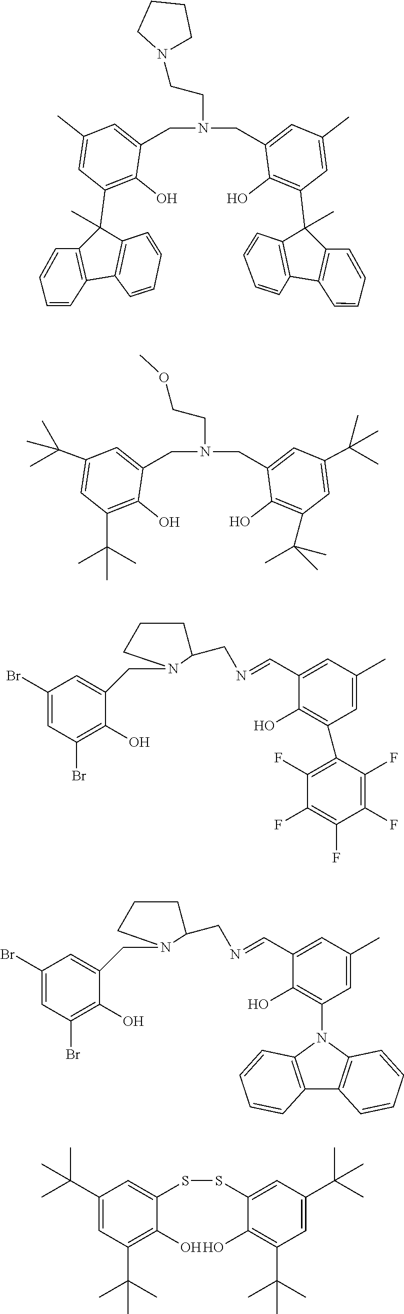

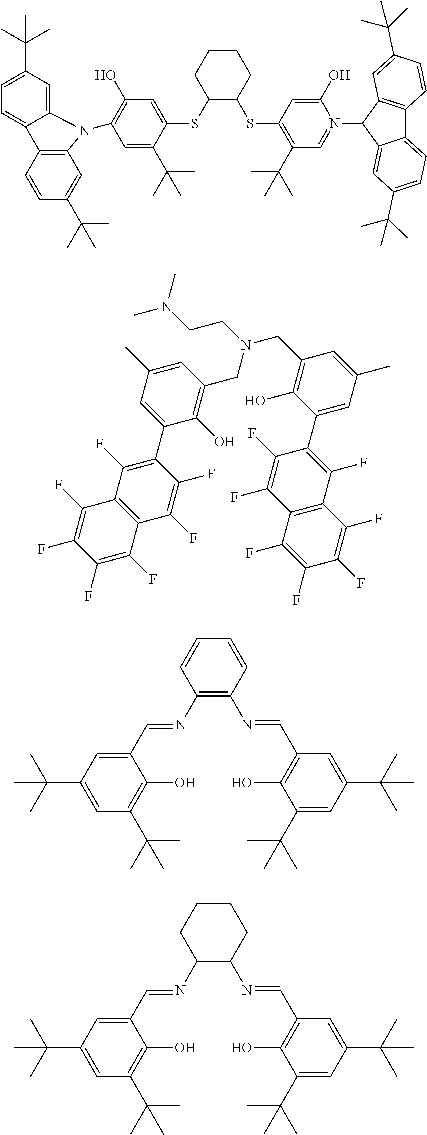

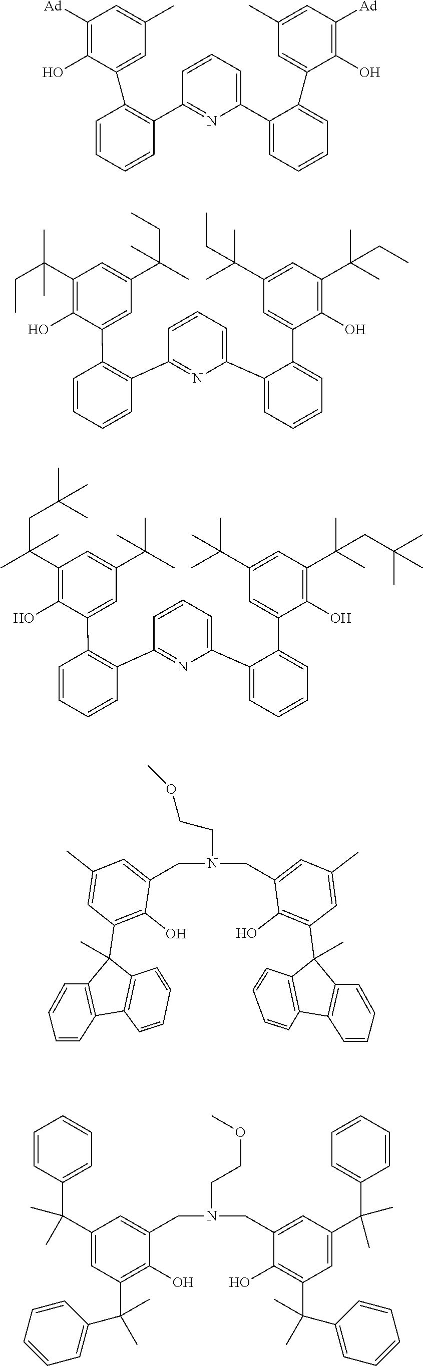

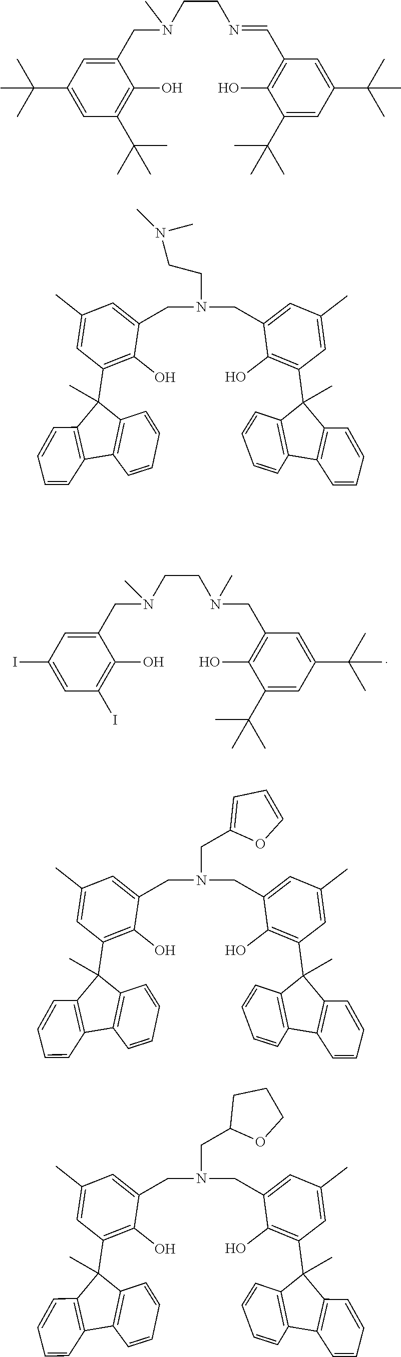

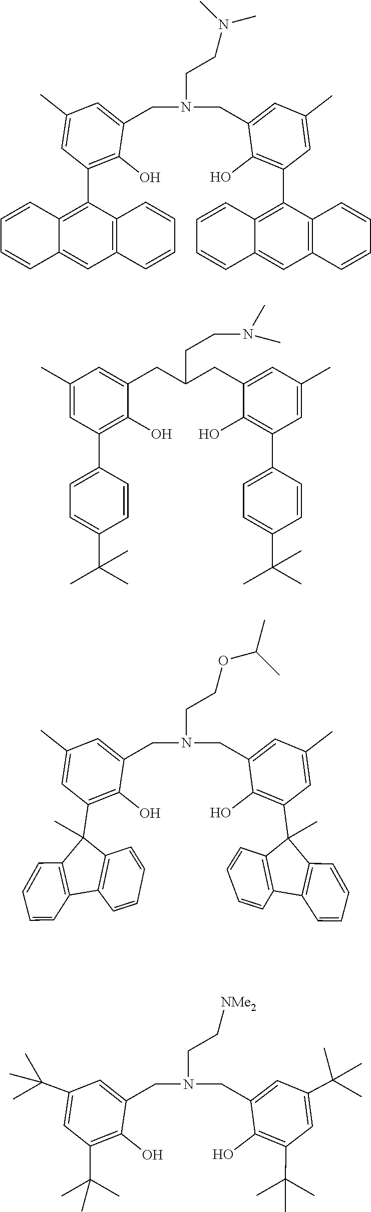

The following describes the experimental process for the entries in Table 1.

### Entry 1

Y[N(SiHMe₂)]₃(THF)₂ (8.26 mg) in 1 g toluene was added to a toluene (1.5 g) solution of the ligand (10.0 mg) at room temperature. After a minute, BBL was added neat. After 15 minutes, isopropanol (˜1 mL) added and the mixture agitated. Solvent removed under vacuum. Washed with isopropanol and hexanes. Dried under vacuum. 430 mg polymer isolated.

### Entry 2

Y[N(SiHMe₂)]₃(THF)₂ (8.26 mg) in 1 g toluene was added to a toluene (1.5 g) solution of the ligand (10.0 mg) at room temperature. After a minute, BBL was added neat. The reaction left at room temperature for 16 hours at room temperature. Isopropanol (˜1 mL) added and the mixture agitated. Solvent removed under vacuum. Washed with isopropanol and hexanes. Dried under vacuum. 1.10 g polymer isolated.

### Entry 3

Y[N(SiHMe₂)]₃(THF)₂ (8.12 mg) in 1 g toluene was added to a toluene (1.5 g) solution of the ligand (10.0 mg) at room temperature. After a minute, BBL was added neat. The reaction left at room temperature for 16 hours at room temperature. 1 mL iPrOH was added and the gel-like polymer was washed with excess hexane. Dried under vacuum. 950 mg polymer isolated.

### Entry 4

Y[N(SiHMe₂)]₃(THF)₂ (9.17 mg) in 1 g toluene was added to a toluene (1.5 g) solution of the ligand (10.0 mg) at room temperature. After three minutes, BBL was added neat. The reaction left at room temperature for 16 hours at room temperature. 1 mL iPrOH was added and the solids were mixed. The polymer was then placed on a frit filter and washed with excess MeOH, hexane and pentane. Dried under vacuum. 1.25 g polymer isolated.

### Entry 5

Y[N(SiHMe₂)]₃(THF)₂ (9.17 mg) in 1 g toluene was added to a toluene (1.5 g) solution of the ligand (10.0 mg) at room temperature. After three minutes, BBL was added neat. The reaction left at room temperature for 16 hours at room temperature. 1 mL iPrOH was added and the solids were mixed. The polymer was then placed on a frit filter and washed with excess MeOH, hexane and pentane. Dried under vacuum. 600 mg polymer isolated.

### Entry 6

Y[N(SiHMe₂)]₃(THF)₂ (8.83 mg) in 1 g toluene was added to a toluene (1.5 g) solution of the ligand (10.0 mg) at room temperature. After three minutes, BBL was added neat. The reaction left at room temperature for 16 hours at room temperature. 1 mL iPrOH was added and the solids were mixed. The polymer was then placed on a frit filter and washed with excess MeOH, hexane and pentane. Dried under vacuum. 1.20 g polymer isolated.

### Entry 7

Y[N(SiHMe₂)]₃(THF)₂ (12.2 mg) in 1 g toluene was added to a toluene (1.5 g) solution of the ligand (10.0 mg) at room temperature. After three minutes, BBL was added neat. The reaction left at room temperature for 16 hours at room temperature. 1 mL iPrOH was added and the solids were mixed. The polymer was then placed on a frit filter and washed with excess MeOH, hexane and pentane. Dried under vacuum. 800 mg polymer isolated.

### Entry 8

Y[N(SiHMe₂)]₃(THF)₂ (4.8 mg) in 1 g toluene was added to a toluene (1.5 g) solution of the ligand (5.0 mg) at room temperature. After three minutes, BBL was added neat. The reaction left at room temperature for 3 days at room temperature. 1 mL iPrOH was added and the solids were mixed. The polymer was then placed on a frit filter and washed with excess MeOH, hexane and pentane. Dried under vacuum. 250 mg polymer isolated.

### Entry 9

Y[N(SiHMe₂)]₃(THF)₂ (4.85 mg) in 1 g toluene was added to a toluene (1.5 g) solution of the ligand (5.0 mg) at room temperature. After three minutes, BBL was added neat. The reaction left at room temperature for 3 days at room temperature. No viscosity change was observed.

### Entry 10

Y[N(SiHMe₂)]₃(THF)₂ (6.61 mg) in 1 g toluene was added to a toluene (1.5 g) solution of the ligand (5.0 mg) at room temperature. After three minutes, BBL was added neat. The reaction left at room temperature for 16 hours at room temperature. No viscosity change was observed.

### Entry 11

Y[N(SiHMe₂)]₃(THF)₂ (6.28 mg) in 1 g toluene was added to a toluene (1.5 g) solution of the ligand (10.0 mg) at room temperature. After three minutes, BBL was added neat. The reaction left at room temperature for 16 hours at room temperature. No viscosity change was observed.

### Entry 12

Y[N(SiHMe₂)]₃(THF)₂ (7.54 mg) in 1 g methylcycohexane was added to a methylcycohexane (1.5 g) solution of the ligand (10.0 mg) at room temperature. The solution was stirred ˜3 minutes and BBL was added neat. Within a minute, polymer crushes out of solution. Left stirring at room temperature for 16 hours. The solid polymer was isolated by washing MeOH, iPrOH and pentane. Dried under vacuum. 1 g polymer isolated.

### Entry 13

Y[N(SiHMe₂)]₃(THF)₂ (11.61 mg) in 1 g methylcycohexane was added to a methylcycohexane (1.5 g) solution of the ligand (10.0 mg) at room temperature. The solution was stirred ˜3 minutes and BBL was added neat. Within a minute, polymer crushes out of solution. Left stirring at room temperature for 16 hours. NMR showed 63% conversion. The polymer was not isolated.

### Entry 14

Y[N(SiHMe₂)]₃(THF)₂ (11.49 mg) in 1 g methylcycohexane was added to a methylcycohexane (1.5 g) solution of the ligand (10.0 mg) at room temperature. The solution was stirred ˜3 minutes and BBL was added neat. Within a minute, polymer crushes out of solution. Left stirring at room temperature for 16 hours. NMR showed 70% conversion. The polymer was not isolated.

### Entry 15

Y[N(SiHMe₂)]₃(THF)₂ (8.82 mg) in 1 g methylcycohexane was added to a methylcycohexane (1.5 g) solution of the ligand (10.0 mg) at room temperature. The solution was stirred ˜3 minutes and BBL was added neat. Within a minute, polymer crushes out of solution. Left stirring at room temperature for 16 hours. The solid polymer was isolated by washing MeOH and hexanes. Dried under vacuum. 220 mg polymer isolated.

### Entry 16

Y[N(SiHMe₂)]₃(THF)₂ (9.02 mg) in 1 g toluene was added to a toluene (1.5 g) solution of the ligand (10.0 mg) at room temperature. The solution was stirred ˜3 minutes and BBL was added neat. Within a minute, polymer crushes out of solution. Left stirring at room temperature for 16 hours. The solid polymer was isolated by washing MeOH and hexanes. Dried under vacuum. 520 mg polymer isolated.

### Entry 17

Y[N(SiHMe₂)]₃(THF)₂ (10.02 mg) in 1 g toluene was added to a toluene (1.5 g) solution of the ligand (12.0 mg) at room temperature. The solution was stirred ˜3 minutes and BBL was added neat. Within a minute, polymer crushes out of solution. Left stirring at room temperature for 16 hours. The solid polymer was isolated by washing MeOH and hexanes. Dried under vacuum. 610 mg polymer isolated.

### Entry 18

Y[N(SiHMe₂)]₃(THF)₂ (9.35 mg) in 1 g toluene was added to a toluene (1.5 g) solution of the ligand (10.0 mg) at room temperature. The solution was stirred ˜3 minutes and BBL was added neat. Within a minute, polymer crushes out of solution. Left stirring at room temperature for 16 hours. The solid polymer was isolated by washing MeOH and pentane. Dried under vacuum. 1.27 g polymer isolated.

### Entry 19 (Example for Hexanolactone)

Y[N(SiHMe₂)]₃(THF)₂ (8.26 mg) in 1 g toluene was added to a toluene (1.5 g)

solution of the ligand (10.0 mg) at room temperature. The solution was stirred ˜3 minutes and BHL was added neat. Left stirring at room temperature for 16 hours. The gel was agitated with MeOH to precipitate the polymer and the solid polymer was isolated by washing MeOH and hexanes. Dried under vacuum. 750 mg polymer isolated.

### Entry 20

Y[N(SiHMe₂)]₃(THF)₂ (12.35 mg) in 1 g methylcycohexane was added to a methylcycohexane (1.5 g) solution of the ligand (10.0 mg) at room temperature. The solution was stirred ˜3 minutes and BBL was added neat. Left stirring at 65° C. for 16 hours. NMR showed 83% conversion. The polymer was not isolated.

### Entry 21 (Example for Hexanolactone)

Y[N(SiHMe₂)]₃(THF)₂ (9.17 mg) in 1 g toluene was added to a toluene (1.5 g) solution of the ligand (10.0 mg) at room temperature. The solution was stirred ˜3 minutes and BHL was added neat. Within a minute, polymer crushes out of solution. Left stirring at room temperature for 16 hours. NMR showed 75% conversion. The polymer was not isolated.

### Entry 22

Y[N(SiHMe₂)]₃(THF)₂ (9.45 mg) in 1 g toluene was added to a toluene (1.5 g) solution of the ligand (10.0 mg) at room temperature. The solution was stirred ˜3 minutes and BBL was added neat. Left stirring at room temperature for 16 hours. The gel was agitated with MeOH to precipitate the polymer and the solid polymer was isolated by washing MeOH and hexanes. Dried under vacuum. 330 mg polymer isolated.

### Entry 23-28

The polymers were prepared similarly as described in Entry 22

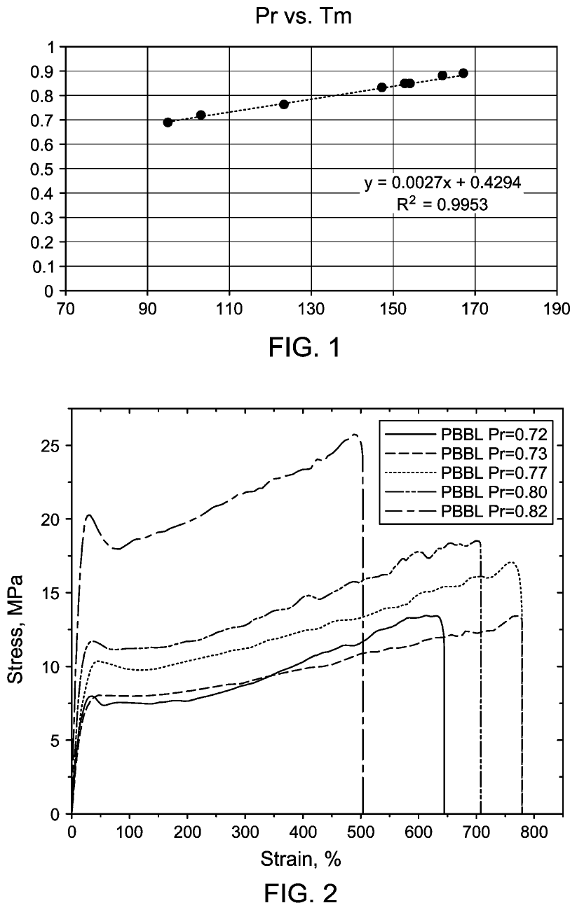

The results indicate that there is a linear relationship between Tm and Pr, which is depicted in FIG. 1.

The following describes examples where an isolated complex was used as a catalyst for polymerization of various lactones.

### Synthesis and Isolation of a Yttrium Metal Complex

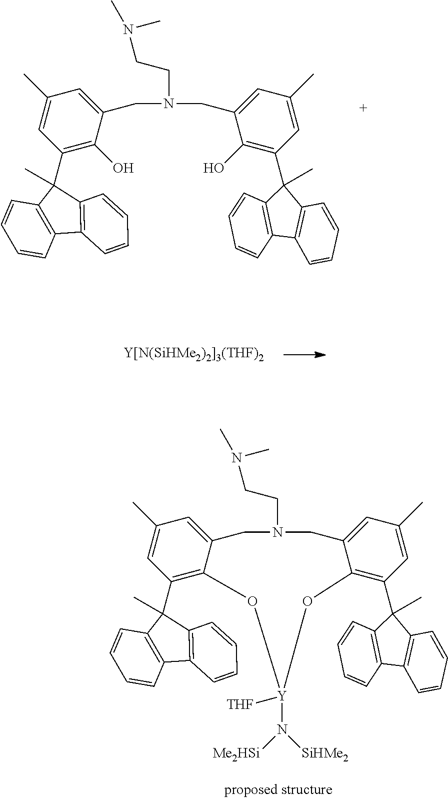

Y[N(SiHMe₂)]₃(THF)₂ (119 mg) in 1 mL benzene was added to a benzene (3 mL) solution of the ligand (130 mg) at room temperature. The homogeneous solution turned to a suspension after 1 hour. Solvent was removed and the solids were washed with 10 mL pentane. The white solids were dried under vacuum. Freshly prepared complex was immediately used for the following reactions.

### Polymerization of β-butyrolactone (BBL)

BBL monomer (883 mg) was added to a 1 g toluene solution of the metal complex (20 mg) at room temperature. Within a minute the solution gelled and the gel was agitated with isopropanol to precipitate the polymer. The polymer was then washed with excess isopropanol and hexanes. Dried under vacuum. 800 mg polymer was isolated. Tm=100.4° C.

### Polymerization of ε-Decalactone

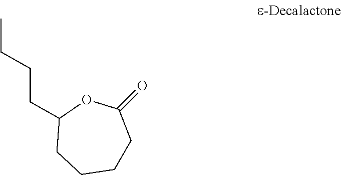

ε-Decalactone monomer (523 mg) was added to a 1 g toluene solution of the metal complex (20 mg) at room temperature. The solution was left at 100° C. for 16 hours. The precipitated solid polymer was isolated and washed with isopropanol and hexanes. Dried under vacuum. 300 mg polymer was isolated. The high Tm obtained by DSC is indicative of stereoselective polymerization to give syndiorich polymer. Tm=105° C.

### Polymerization of Caprolactone

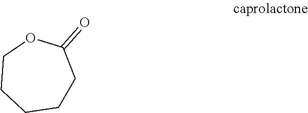

Caprolactone monomer (585 mg) was added to a 1 g toluene solution of the metal complex (20 mg) at room temperature. The solution instantly gels and comes to a stop. The polymer was isolated and washed with iPrOH and hexanes (4 mL each). Dried under vacuum to isolate 550 mg polymer. Tm=54.2° C.

### Polymerization of 4-propyl-2-oxetanone

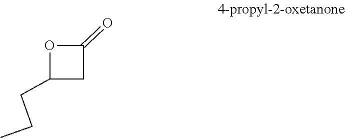

Monomer (585 mg) was added to a 1 g toluene solution of the metal complex (20 mg) at room temperature. Within 15 minutes the solution gelled and the gel was agitated with isopropanol to precipitate the polymer. The polymer was then washed with excess isopropanol and hexanes. Dried under vacuum. The polymer was isolated in 92% yield. Pr value of 0.78 is indicative of syndiorich polymer. Pr=0.78. Pr is the probability of racemic linkages between monomer units, which is described in literature Ebrahimi, Tannaz (2017) “Synthesis and rheological characterization of polyhydroxybutyrate with different topologies and microstructures,” University of British Columbia.

The higher yield in 15 minutes shows the benefit of using isolated complex vs. in situ generated catalyst (Table 1, Entry 21) where only 75% conversion was obtained after 16 hours.

### Optional Polymerization

Optionally, once the isolated or in situ catalyst system is formed, the polymerization can be initiated through an alcohol/amine exchange. In doing so, the —NR₂ group can be replaced by an —OR to create an an alkoxide or aryloxide polymerization initiator.

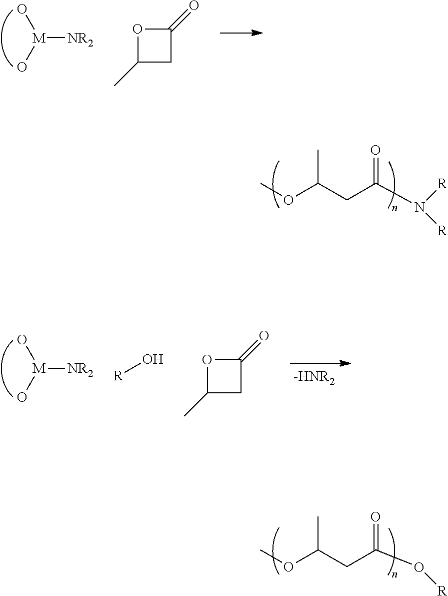

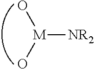

=representing catalyst/precatalyst
M=metal center

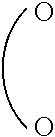 [SMILES: O ; O]

=representing bidentate ligands described in the study

### Utilization of High-Throughput Screening for Lactone Polymerization

High-throughput screening (HTS) is a valuable tool that can provide rapid screening and reaction optimization. Therefore, a series of experiments were conducted to explore how solvent and temperature affects the polymer properties.

For example, it has been discovered that by changing solvent from toluene to methylcyclohexane (Experiment 1), a drop in Tm can be observed. By increasing the temperature to 50° C. and 70° C., significant drop in Tm was achieved. This has industrial relevance since lower Tm will provide a polymer with better processability. The drop that was measured by DSC was supported by ¹³C NMR evidence as well.

A ligand has also been synthesized with a same substitution pattern (i.e., the substituents ortho and para to the phenol oxygen were kept the same) with only a change in the coordination environment around the metal center (Experiment 2). A significant drop in Tm was observed, even at 50° C., which proves that coordination number/environment is also result effective.

In another example, a ligand with different substituents was selected and 15-20° C. drop in Tm was observed, similar to the experiment above (Experiment 3).

It has also been discovered that the temperature and solvent dependency is also highly dependent on the ortho phenol substituents (Experiment 4). This is shown by using a significantly different ligand with electron drawing ortho substitution as shown below. The catalyst produced a polymer with essentially identical Tm both at 30° C. and 50° C. in contrast to the experiments 1-3 reported above (in those cases, Tm drops significantly, whereas in this case, Tm remained about the same).

### General Experimental Procedure

The specific ligand and Y[N(SiHMe₂)]₃(THF)₂ are combined in the reaction solvent at room temperature. After stirring for 3-5 minutes, the solution was added to a lactone solution in the reaction solvent at the specified temperature. For these experiments, the lactone used was BBL. The reaction was stirred for 30 minutes and quenched by adding an alcohol such as isopropanol, methanol or ethanol. The precipitated polymer was isolated and washed with hexanes and dried under vacuum. The TON (turnover number) was calculated based on isolated yield (mass polymer isolated/molar mass of lactone)/moles of catalyst).

### Experiment 1

The metal ligand combination used is as follows.

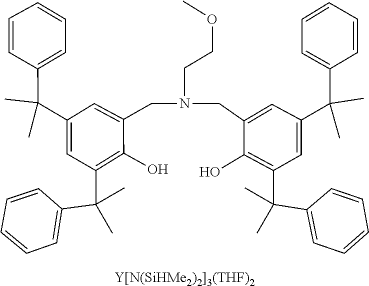

The solvent used in experiment 1 was methylcyclohexane.

TABLE 3

| | | | [Lactone]/ | | | | |
|---|---|---|---|---|---|---|---|
| | Lactone | catalyst | [Cat] | Temp, | Yield | Conver- | |
| | (mg) | (mg) | (equivalents) | ° C. | (mg) | sion | TON |
| A | 739 | 13.5 | 670 | 30 | 411 | 56% | 367 |
| B | 739 | 13.5 | 670 | 30 | 473 | 64% | 422 |
| C | 739 | 13.5 | 670 | 50 | 436 | 59% | 389 |
| D | 739 | 13.5 | 670 | 50 | 452 | 61% | 404 |
| E | 739 | 13.5 | 670 | 70 | 270 | 37% | 241 |
| F | 739 | 13.5 | 670 | 70 | 320 | 43% | 286 |

TABLE 4

| T | | Pr | | Td (DSC | Tm (DSC | |
|---|---|---|---|---|---|---|
| (° C.) | Pr NMR | Estimated | Tg | Peak) | Peak) | ΔHf |
| 30 | 0.84 | 0.85919 | 2.51 | 110 | 156.3 | 61.4 |
| 30 | 0.84 | 0.85177 | 1.31 | 108.6 | 153.6 | 57.8 |
| 50 | 0.82 | 0.82922 | 1.74 | 101.8 | 145.4 | 50.2 |
| 50 | 0.82 | 0.83994 | 5.68 | 99.9 | 149.3 | 58.8 |
| 70 | 0.81 | 0.82179 | 3.03 | 94.2 | 142.7 | 52.3 |
| 70 | 0.81 | 0.79594 | −3.8 | 85.3 | 133.3 | 47.7 |

Each of the Tm obtained is much lower than the 162° C. in Table 1, entry 2.

### Experiment 2

The metal ligand combination used is as follows.

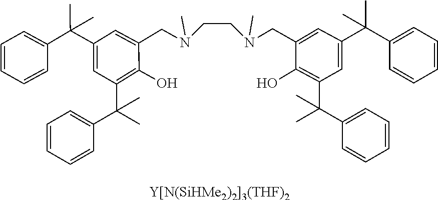

The solvent used in experiment 2 was methylcyclohexane.

TABLE 5

| | | | [Lactone]/ | | | | |
|---|---|---|---|---|---|---|---|
| | Lactone | catalyst | [Cat] | Temp, | Yield | Conver- | |
| | (mg) | (mg) | (equivalents) | ° C. | (mg) | sion | TON |
| A | 620 | 14.25 | 600 | 30 | 203 | 33% | 176 |
| B | 620 | 14.25 | 600 | 30 | 231 | 37% | 200 |
| C | 620 | 14.25 | 600 | 30 | 231 | 37% | 200 |
| D | 620 | 14.25 | 600 | 50 | 225 | 36% | 195 |
| E | 620 | 14.25 | 600 | 50 | 220 | 35% | 191 |

| | | | | | |
|---|---|---|---|---|---|
| F | 620 | 14.25 | 600 | 50 | error |

TABLE 6

| | | Tc (DSC | Tm (DSC | |
|---|---|---|---|---|
| T (° C.) | Tg | Peak) | Peak) | ΔHf |
| 30 | −2.78 | 100.1 | 147.3 | 54.6 |
| 30 | −7.22 | 99.9 | 145.4 | 59.4 |
| 30 | −12.6 | 100.1 | 144.3 | 47.4 |
| 50 | −3.02 | 106.6 | 146.3 | 42.5 |
| 50 | −1.29 | 104.2 | 145.6 | 64.7 |

Each of the Tm obtained is much lower than the 167° C. in Table 1, entry 3.

### Experiment 3

The metal ligand combination used is as follows.

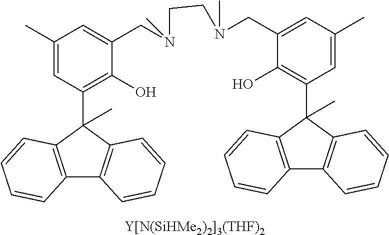

The solvent used in experiment 3 was methylcyclohexane.

TABLE 7

| | | | [Lactone]/ | | | | |
|---|---|---|---|---|---|---|---|
| | Lactone | catalyst | [Cat] | Temp, | Yield | Conver- | |
| | (mg) | (mg) | (equivalents) | ° C. | (mg) | sion | TON |
| A | 620 | 14.25 | 600 | 30 | 296 | 48% | 236 |
| B | 620 | 14.25 | 600 | 30 | 351 | 57% | 279 |
| C | 620 | 14.25 | 600 | 30 | 352 | 57% | 280 |
| D | 620 | 14.25 | 600 | 50 | 280 | 45% | 223 |
| E | 620 | 14.25 | 600 | 50 | 274 | 44% | 218 |
| F | 620 | 14.25 | 600 | 50 | 188 | 30% | 150 |

TABLE 8

| | | Tc (DSC | Tm (DSC | |
|---|---|---|---|---|
| T (° C.) | Tg | Peak) | Peak) | ΔHf |
| 30 | −0.92 | 95.3 | 149 | 50.8 |
| 30 | −0.42 | 93.9 | 148 | 47.1 |
| 30 | −1.39 | 92.3 | 145.9 | 44.6 |
| 50 | −0.2 | 90.7 | 138.2 | 50.6 |
| 50 | −2.05 | 86.3 | 137.8 | 48.6 |
| 50 | −5.56 | 86.1 | 135.7 | 48.8 |

Each of the Tm obtained is much lower than the 154.5° C. in Table 1, entry 5.

### Experiment 4

The metal ligand combination used is as follows.

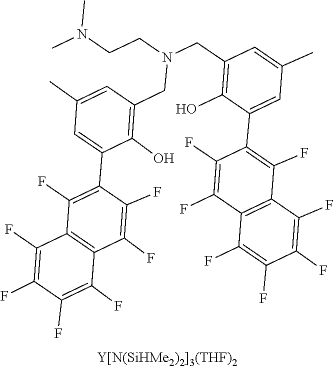

The solvent used in experiment 4 was methylcyclohexane.

TABLE 9

| | | | [Lactone]/ | | | | |
|---|---|---|---|---|---|---|---|
| | Lactone | catalyst | [Cat] | Temp, | Yield | Conver- | |
| | (mg) | (mg) | (equivalents) | ° C. | (mg) | sion | TON |
| A | 620 | 13.5 | 600 | 30 | 274 | 44% | 265 |
| B | 620 | 13.5 | 600 | 30 | 273 | 44% | 264 |
| C | 620 | 13.5 | 600 | 30 | 292 | 47% | 282 |
| D | 620 | 13.5 | 600 | 50 | 260 | 42% | 251 |
| E | 620 | 13.5 | 600 | 50 | 269 | 43% | 260 |
| F | 620 | 13.5 | 600 | 50 | 296 | 48% | 286 |

TABLE 10

| | | Tc | Tm | |
|---|---|---|---|---|
| T(° C.) | Tg | (DSC peak) | (DSC peak) | ΔHf |
| 30 | −11.7 | 98.1 | 143 | 44.3 |
| 30 | −4.41 | 98.5 | 145.2 | 39.3 |
| 30 | −7.81 | 87.8 | 142.9 | 51.7 |
| 50 | −1.31 | 81.75 | 139.6 | 52.8 |
| 50 | −3.16 | 89.9 | 139.7 | 44.2 |
| 50 | −3.28 | 92.98 | 141 | 48.8 |

Each of the Tm obtained is comparable to the 142° C. in Table 1, entry 12.

### Polymerization

Some polymers made with the present technological advancement are syndiotactic-enriched polyhydroxyalkanoate polymers as they are highly syndiotactic compositions. It is of industrial interest to lower the Tm of syndiotactic PHA polymers in order to process them in a commercial setting. One way to achieve this is to introduce copolymers derived from longer chain lactones, such as ethyl, propyl, butyl, etc., as opposed to the methyl substituent of BBL. However, this adds to the cost of production making these polymers less likely to achieve commercial success. No to be bound by theory, but it is believed that the alpha isomers of BBL disrupt the crystallinity and lower the Tm of the resulting polymer even though it is a PHA “homopolymer.” This hypothesis was tested by producing a mixture of BBL and its alpha isomer (the mixture being about 3-4% alpha isomer) through a route reported in literature (see, Kramer, J. W. et al. (2006) “Practical δ-Lactone Synthesis: Epoxide Carbonylation at 1 Atm,” Org. Lett., v. 8(17), pp. 3709-3712 and Getzler, Y. et al. (2002) “Synthesis of β-Lactones: A Highly Active and Selective Catalyst for Epoxide Carbonylation,” J. Am. Chem. Soc. v. 124(7), pp. 1174-1175, the entirety of both of which are hereby incorporated by reference in their entirety.) No effort was made to separate the isomer and the presence of the alpha isomer was confirmed by ¹H NMR spectroscopy. While BBL was considered here, other beta substituted lactones that are produced from carbonylation of epoxides could have an alpha isomer in small quantities depending on the conditions.

TABLE 11A

| | Mw | Mn | | Pr | |
|---|---|---|---|---|---|
| Entry | (MALLS) | (DRI) | Tm | (¹³CNMR) | Comments |
| 1 | 31,613 | 25,783 | 162 | 0.88 | Commercial monomer |
| 2 | 79,851 | 26,984 | 141.85 | NA | Monomer from |
| | | | | | carbonylation |
| 3 | 24,229 | 17,586 | 154.25 | 0.85 | Commercial monomer |
| 4 | 153,853 | 90,618 | 122.3 | NA | Monomer from |
| | | | | | carbonylation |
| 5 | 9,190 | 9,821 | 123.5 | 0.76 | Commercial monomer |
| 6 | 114,126 | 64,434 | 106.4 | NA | Monomer from |
| | | | | | carbonylation |

TABLE 11B

| Entry | Ligand/Metal Combination In Situ |
|---|---|
| 1 2 | 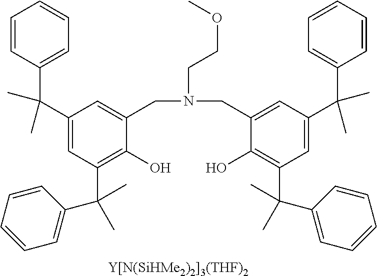 |
| 3 4 | 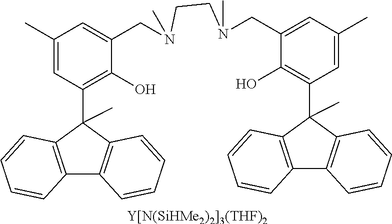 |
| 5 6 | 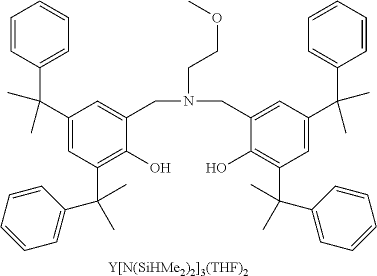 |

The commercial monomer was a BBL. Monomer from carbonylation means that a cobalt based carbonylation catalyst was used and reacted with propylene oxide (commercial) with carbon monoxide to produce quantities of the monomer (including the other isomer). Both the commercial monomer and the monomer from carbonylation of propylene oxide were distilled at 90° C. at 25 torr for purification, with no further treatment. For table 11, as above, the same general polymerization procedure was used (i.e., room temperature, toluene, 16 hours).

Polymerization resulted in a significant drop in Tm without the need of a co-monomer.

The ability to tune the Pr (Tm) of the polymers allowed for control of the tensile properties of the PHA polymers (i.e., generate a polymer to satisfy predetermined tensile properties). The predetermined tensile properties can be achieved by causing Pr to range from 0.7 to 0.85. Results for selected polymers are shown FIG. 2, which shows an exemplary range of properties a polymer made by the present technological advancement can possess. Table 12 provides the tensile properties of selected PBBL homopolymers, wherein “Sec Mod” is section modulus. All the tensile properties in Table 12 were computed from the stress-strain plots in FIG. 2. Sec Mod: modulus measured at 2% strain. Strain at yield and Yield stress:

measured at the peak in the stress-strain curve. Strain at break: maximum strain reached before break. Tensile stress or tensile strength: this is the ultimate tensile strength (max stress reached before break). Ranges for these values are defined by any combination of the values recited in Table 12, +/−10%.

TABLE 12

| | | Sec | | Yield | | Tensile |
|---|---|---|---|---|---|---|
| Tm | | Mod | Strain at | Stress | Strain at | Stress |
| ° C. | Pr | MPa | yield % | MPa | Break % | MPa |
| 103.4 | 0.72 | 44.8 | 33 | 7.9 | 550 | 13.1 |
| 142 | 0.82 | 147 | 30 | 20.2 | 800 | 25.7 |
| 122.4 | 0.77 | 46.9 | 48 | 10.3 | 700 | 16.5 |
| 109 | 0.73 | 43.7 | 56 | 8.1 | 750 | 13 |
| 138.3 | 0.80 | 76.9 | 38 | 11.8 | 797 | 20.7 |

The tensile properties of the polyhydroxyalkanoate polymer include at least one of Tm ranging from 103 to 140° C., Pr ranging from 0.7 0.85, Sec Mod ranging from 40 to 150 Mpa, strain at yield ranging from 27 to 60 MPa, strain at break ranging from 700 to 800, and tensile stress ranging from 13 to 26 MPa.

Syndiotactic PHB polymers are promising candidates that are potentially (bio) degradable replacements with comparable or superior properties compared to some LLDPE resins. There are only a few catalyst systems reported in published literature [cited in the body] that can convert racemic beta-butyrolactone to syndiotactic PHB. Here we report a new family of ligand and catalyst systems that can produce syndiotactic PHB from racemic starting material. One would not expect to see any tacticity enrichment in the resulting polymer that is produced by catalyst systems reported in Table 2 (Except Entry 7). For example Entry 1, 4, 10 are the expected results for a polymer produced by symmetric catalyst systems. These can be considered truly atactic PHB by their Pr values. One would expect microstructure enrichment by using chiral or asymmetric ligands. For example, an attempt was made to use an asymmetric ligand (Entry 7) and the catalyst system unexpectedly produced truly atactic PHB.

However, catalyst systems in Entry 2,3,5 produce the polymers with the highest syndiotacticity (Pr) observed among the polymers produced in Table 2. The observed tacticity is also correlated with the high Tm of the polymers. These suggest the importance of the substituents on the phenols and how they can be fine-tuned to produce PHB with desired tacticity without using complicated synthetic methods and expensive starting materials to produce chiral or asymmetric ligands

Any of the foregoing polymers and compositions in combination with optional additives (anti-oxidants, colorants, dyes, stabilizers, filler, etc.) may be used in a variety of end-use applications produced by methods known in the art.

All documents described herein are incorporated by reference herein, including any

priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A method for preparing a polyhydroxyalkanoate (PHA) polymer by ring-opening polymerization, comprising:
polymerizing a lactone in a presence of a solvent and a catalyst with a yttrium metal center under reaction conditions;
controlling the polymerization to derive a polymer from the lactone with the polymer having predetermined tensile properties, wherein a Tm of the polymer ranges from 90 to 170° C., and the tensile properties are determined by a ligand of the catalyst, the solvent, and a temperature of the reaction conditions; and
recovering the PHA polymer.

2. The method of claim 1, wherein the solvent is methcyclohexane, the controlling includes controlling the polymerization based on a relationship between the Tm and the Pr, and the controlling includes having the temperature of the reaction conditions range from 30 to 70° C.

3. The method of claim 2, wherein the lactone includes a beta-butyrolactone monomer and an alpha isomer thereof, with the alpha isomer being 1-5 wt % of the lactone.

4. The method of claim 1, wherein the lactone includes a beta-butyrolactone monomer.

5. The method of claim 3, further comprising generating the catalyst in-situ from one or more of the following ligands and metal precursor Y[N(SiHME₂)₂]₃(THF)₂,

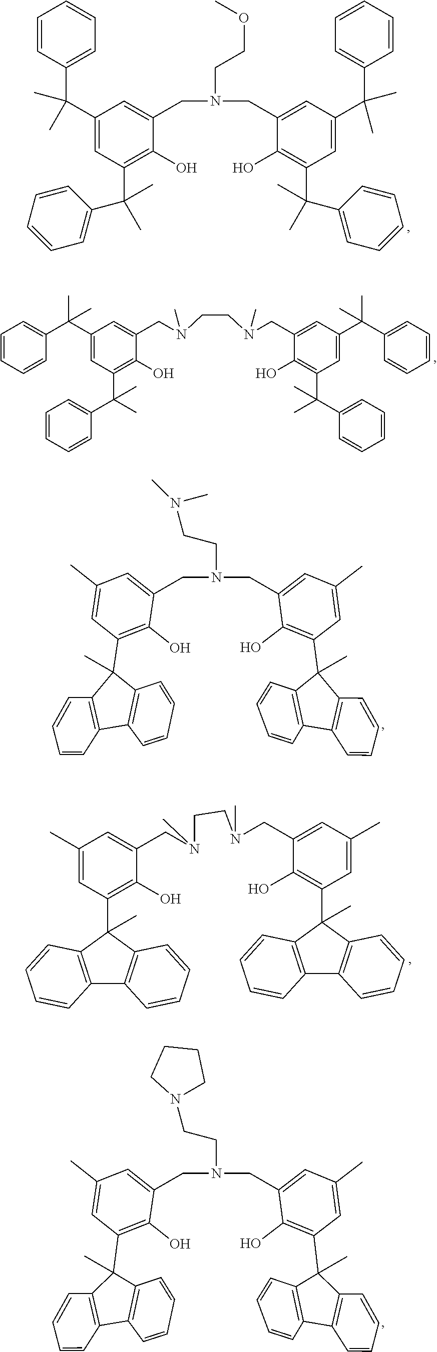

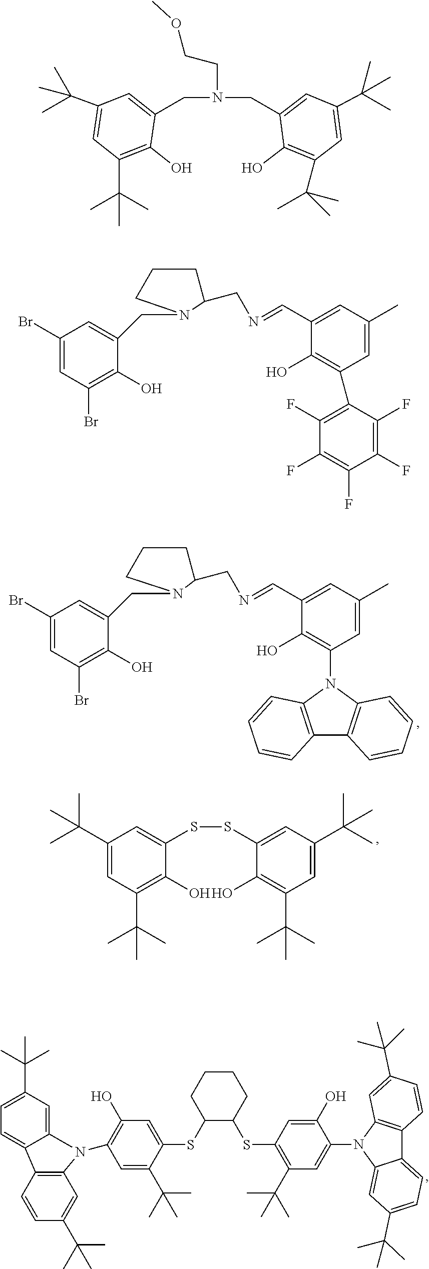

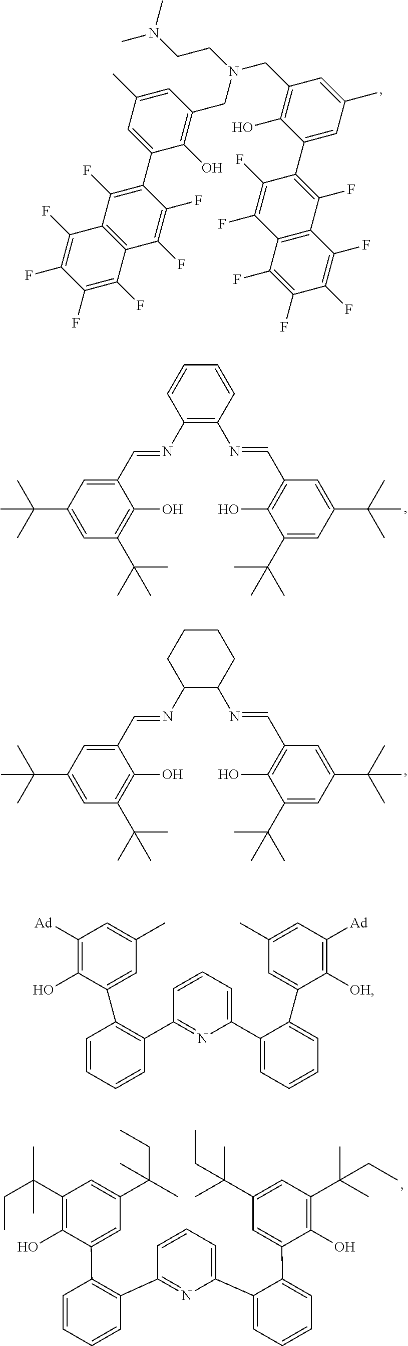

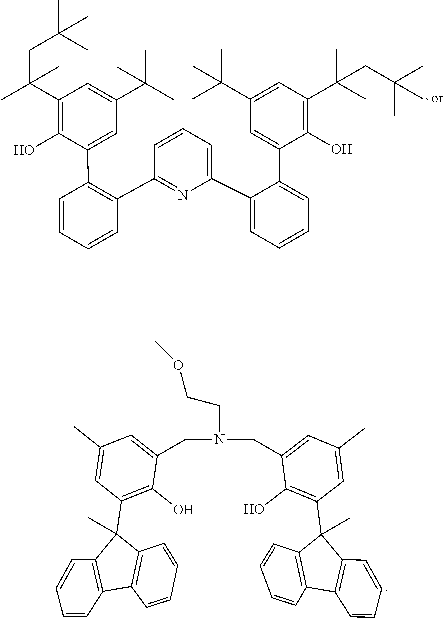 [SMILES: CC(C)(C)CC(C)(C)c1cc(C(C)(C)C)cc(-c2ccccc2-c2cccc(-c3ccccc3-c3cc(C(C)(C)C)cc(C(C)(C)CC(C)(C)C)c3O)n2)c1O ; COCCN(Cc1cc(C)cc(C2(C)c3ccccc3-c3ccccc32)c1O)Cc1cc(C)cc(C2(C)c3ccccc3-c3ccccc32)c1O]

6. The method according to claim 1, wherein the lactone is selected from the group consisting of:

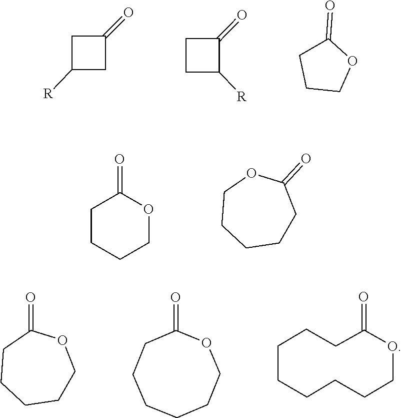

7. The method of according to claim 1, wherein the lactone is β-butyrolactone.

8. The method of claim 1, wherein the Tm of the PHA polymer ranges from 50 to 170° C.

9. The method of claim 1, wherein the solvent is methylcyclohexane, the reaction temperature ranges from 30 to 70° C., and a Tm of the PHA polymer ranges from 157 to 133° C.

10. The method of claim 1, wherein a Mw of the PHA polymer ranges from 10,000 to 154,000 (MALLS).

11. The method of claim 1, wherein the predetermined tensile properties are achieved by causing Pr to range from 0.7 to 0.85.

12. A method for preparing a polyhydroxyalkanoate (PHA) polymer by ring-opening polymerization, comprising:
polymerizing a lactone in a presence of a solvent and a catalyst with a yttrium metal center under reaction conditions, wherein the catalyst was formed in situ from a metal ligand combination selected from the group consisting of 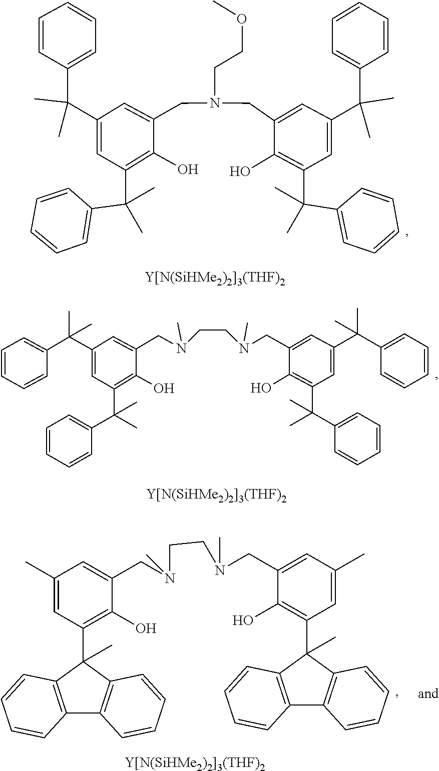 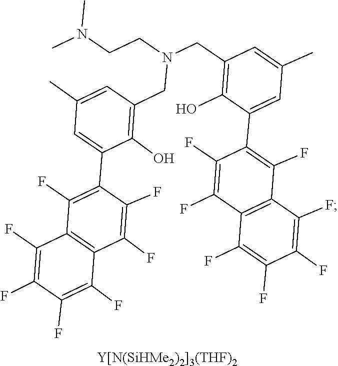
and recovering the PHA polymer.

13. The method of claim 12, wherein the tensile properties include modulus measured at 2% strain, strain at yield, strain at break, and tensile stress.

14. A polyhydroxyalkanoate polymer obtainable by the method according to claim 1.

15. The polyhydroxyalkanoate polymer of claim 14, wherein the tensile properties of the polyhydroxyalkanoate polymer include at least one of Tm ranging from 103 to 140° C., Pr ranging from 0.7 0.85, Sec Mod ranging from 40 to 150 Mpa, strain at yield ranging from 27 to 60 MPa, strain at break ranging from 700 to 800, and tensile stress ranging from 13 to 26 MPa.

16. The method of claim 12, wherein the lactone includes a beta-butyrolactone monomer and an alpha isomer thereof, with the alpha isomer being 1-5 wt % of the lactone.
